(19) United States
(12) Patent Application Publication
(10) Pub. No.: US 2004/0011887 A1
(43) Pub. Date: Jan. 22, 2004

(54) Fuel injection system for an internal combustion engine

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/182,530

(22) PCT Filed: Dec. 7, 2001
(86) PCT No.: PCT/DE01/04623

(30) Foreign Application Priority Data
Dec. 16, 2000 (DE) 100 62 896.6

(51) Int. Cl. F02M 59/00

(52) U.S. Cl. 239/533.2

(57) ABSTRACT

The fuel injection system has a pump work chamber (18), which is defined by a pump piston (14) and can be filled with fuel via a communication controlled by a control valve device (30; 130) and can be made to communicate with a relief chamber (31); during a given fuel injection, the pump work chamber (18) is disconnected from the relief chamber (31) by the control valve device (30; 130), and to terminate the fuel injection it is made to communicate with the relief chamber (31) by the control valve device (30; 130). A fuel injection valve (20) of the fuel injection system has an injection valve member (22), which controls at least one injection opening and is urged in the opening direction (28) by the pressure prevailing in the pump work chamber (18), counter to a closing force. To interrupt the fuel injection, a communication of the pump work chamber (18) with a pressure chamber (32) is also controlled by the control valve device (30; 130), and the injection valve member (22) is urged in the closing direction at least indirectly by the pressure prevailing in the pressure chamber (32).

### PRIOR ART

The invention is based on a fuel injection system for an internal combustion engine as generically defined by the preamble to claim 1.

One such fuel injection system is known from German Patent Disclosure DE 198 35 494 A1. This fuel injection system has a pump work chamber, defined by a pump piston, that can filled with fuel via a connection controlled by a control valve device and can be made to communicate with a relief chamber. During a given fuel injection, the pump work chamber is disconnected from the relief chamber by the control valve device, and to terminate the fuel injection, the pump work chamber is made by the control valve device to communicate with the relief chamber. The fuel injection system also has a fuel injection valve with an injection valve member that controls at least one injection opening and that is urged in the opening direction by the pressure prevailing in the pump work chamber and in the closing direction by a closing force. The closure of the fuel injection valve occurs upon relief of the pump work chamber via the control valve device into the relief chamber, by means of the closing force acting on the injection valve member. A brief closure and reopening of the fuel injection valve is possible here only with difficulty, since the pressure in the pump work chamber decreases and builds up again only after a delay. A brief closure and reopening of the fuel injection valve for a preinjection and/or postinjection of a slight amount of fuel before and after the main injection of a large fuel quantity is advantageous in view of pollutant emissions and the noise produced by the engine.

### ADVANTAGES OF THE INVENTION

The fuel injection system of the invention having the characteristics of claim 1 has the advantage over the prior art that by means of the control valve device, the fuel injection valve can be closed briefly to interrupt the fuel injection by means of the pressure prevailing in the pump work chamber. In addition to the closing force, the pressure prevailing in the pump work chamber urges the injection valve member in the closing direction, so that the fuel injection valve closes quickly. The fuel injection system of the invention thus enables a preinjection and/or a postinjection of a slight amount of fuel.

In the dependent claims, advantageous features and refinements of the fuel injection system of the invention are recited. The embodiment in accordance with claim 4 makes a control valve device possible that switches quickly and is simple in design.

### DRAWING

Two exemplary embodiments of the invention are shown in the drawing and explained in further detail in the ensuing description.

FIG. 1 shows a fuel injection system for an internal combustion engine schematically in a first exemplary embodiment;

FIG. 2 shows the fuel injection system with a control valve device in a second exemplary embodiment, in a first switching position;

FIG. 3 shows the control valve device of FIG. 2 in a second switching position; and

FIG. 4 shows the control valve device of FIG. 2 in a third switching position.

### DESCRIPTION OF THE EXEMPLARY EMBODIMENTS

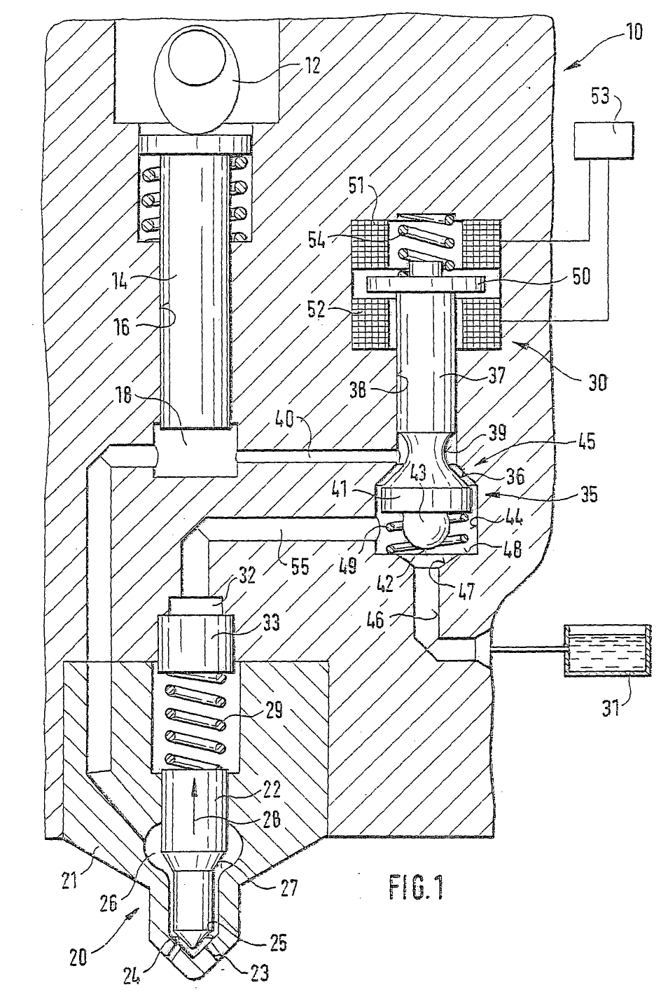

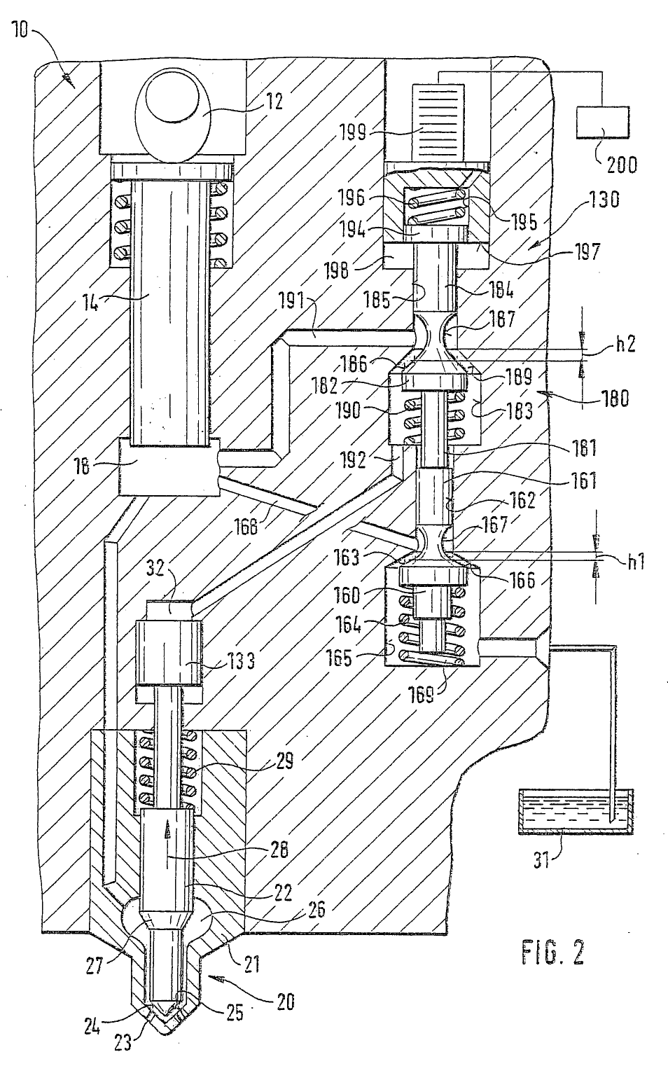

In FIGS. 1 and 2, a fuel injection system for an internal combustion engine 10, in particular a self-igniting internal combustion engine for a motor vehicle, is shown. The fuel injection system is embodied as a so-called unit fuel injector, and a separate unit fuel injector is provided for each cylinder of the engine 10. The engine 10 has a camshaft with cams 12, by way of which a pump piston 14 of the fuel injection system is driven in a reciprocating motion. The pump piston 14 is guided sealingly in a bore 16 and in the bore 16 defines a pump work chamber 18. The pump piston 14 is kept in contact with the cam 12 by a prestressed compression spring 15.

The fuel injection system furthermore has a fuel injection valve 20, which has an injection valve member 22 guided axially displaceably in a valve body 21. The valve body 21, in its end region toward the combustion chamber of the cylinder of the engine 10, has at least one and preferably more injection openings 23. The injection valve member 22, in its end region toward the combustion chamber, has a sealing face 24, which for instance is approximately conical, and which cooperates with a valve seat 25, embodied in the valve body 21, from which seat the injection openings 23 lead away. An annular chamber 26 surrounding the injection valve member 22 is embodied in the valve body 21 and communicates with the pump work chamber 18. The injection valve member 22 has a pressure shoulder 27, disposed in the annular chamber 26, by way of which shoulder the pressure prevailing in the annular chamber 26 exerts a force acting on the injection valve member 22 in its opening direction 28. The injection valve member 22 is urged in the closing direction, that is, counter to the opening direction 28, by a force generated by a prestressed compression spring 29. By means of the pressure generated in the pump work chamber 18 in the pumping stroke by the pump piston 14, which pressure also prevails in the annular chamber 26, the injection valve member 22 is movable in the opening direction 28 counter to the force of the closing spring 29 and thus uncovers the injection openings 23, through which fuel is injected into the combustion chamber of the engine 10. To terminate the fuel injection, the injection valve member 22 is pressed with its sealing face 24 in the closing direction into the valve seat 25 on the valve body 21, so that the injection openings 23 are closed.

Below, the fuel injection system of FIG. 1 will be explained in further detail in terms of a first exemplary embodiment. The fuel injection system has a control valve device 30, by which a communication of the pump work chamber 18 with a relief chamber 31 is controlled; the relief chamber is a region in which low pressure prevails, rather than the high pressure generated by the pump piston 14. The relief chamber 31 is for instance a region that communicates with a fuel tank. In the intake stroke of the pump piston 14, an aspiration of fuel also occurs out of the relief chamber into the pump work chamber 18. The control valve device 30 also controls a communication of the pump work chamber 18 with a pressure chamber 32. The pressure prevailing in the pressure chamber 32 acts on a longitudinally displaceably guided piston 33. The closing spring 29 acting on the injection valve member 22 is braced on the side of the piston 33 remote from the pressure chamber 32.

The control valve device 30 has a control valve member 35, which is guided displaceably in the longitudinal direction and which in a first longitudinal direction has a first sealing face 36, which for instance is embodied approximately conically. The sealing face 36 is adjoined in the longitudinal direction by a shaft 37, which is guided sealingly and longitudinally displaceably in a bore 38 of a control valve body. At the transition from the sealing face 36 to the shaft 37, a plunge cut 39 is embodied on the control valve member 35. In the region of the plunge cut 39 of the control valve member 35, a connection 40 to the pump work chamber 18 discharges into the bore 38. On the side opposite from the shaft 37, the sealing face 36 is adjoined by a cylindrical portion 41 of the control valve member 35, which has a larger diameter than the shaft 37. A second sealing face 42 is disposed on the end region of the portion 41 of the control valve member 35, in the longitudinal direction opposite that of the first sealing face 36; this second sealing face is formed for instance by a ball 43 connected to the face end of the portion 41. The diameter of the ball 43 is less than the diameter of the portion 41.

The portion 41 and the ball 43 of the control valve member 35 are disposed in an enlarged-diameter bore portion 44, compared to the bore 38, of the control valve body. The transition from the bore portion 44 to the bore 38 is for instance embodied nearly conically and forms a first valve seat 45, with which the first sealing face 36 of the control valve member 35 cooperates. On its end remote from the bore 38, the bore portion 44 changes over again to a bore 46 of smaller diameter; the transition is embodied approximately conically, for instance, and forms a second valve seat 47, with which the second sealing face 42 of the control valve member 35 cooperates. Also formed at the end of the bore portion 44 on the second valve seat 47 is an annular shoulder 48, between which and the face end, surrounding the ball 43, of the portion 41 of the control valve member 35, a prestressed compression spring 49 is fastened. By means of the compression spring 49, the control valve member 35 is urged with its first sealing face 36 toward the first valve seat 45. A connection 55 to the pressure chamber 32 discharges into the bore portion 44.

In the end region of the shaft 37 remote from the plunge cut 39, the control valve member 35 has a flange 50. Offset in the longitudinal direction from the flange 50, there are a first coil 51 and a second coil 52, on one side and the other of the flange, respectively. The coils 51, 52 are connected electrically with a control device 53. The flange 50 of the control valve member 35 represents a magnet armature and together with each of the coils 51, 52 forms a respective electromagnet. A prestressed compression spring 54 is braced on the flange 50, on the side remote from the shaft 37; it acts counter to the compression spring 49 and urges the control valve member 35, with its second sealing face 42, toward the second valve seat 47.

If there is no current supplied to either coil 51, 52, then the control valve member 35 is in a middle position, shown in FIG. 1, in which the first sealing face 36 is lifted from the first valve seat 45 and the second sealing face 42 is also lifted from the second valve seat 47. The pump work chamber 18 communicates, by means of the control valve device 30, with both the relief chamber 31 and the pressure chamber 32. It is accordingly impossible for high pressure to build up in the pump work chamber 18. Upon the intake stroke of the pump piston 14, this piston aspirates fuel from the relief chamber 31 into the pump work chamber 18. When the fuel injection is to begin, in the pumping stroke of the pump piston 14, the first coil 51 is supplied with current, so that the flange 50 is attracted by the coil 51, counter to the force of the compression spring 54. As a result, the control valve member 35, with its first sealing face 36, is put into contact with the first valve seat 45, and the pump work chamber 18 is thus disconnected from the relief chamber 31 and from the pressure chamber 32. As a result, high pressure builds up in the pump work chamber 18 that also acts in the annular chamber 26 of the fuel injection valve 20 and opens this valve. To interrupt the fuel injection, the first coil 51 is no longer supplied with current, and instead the second coil 52 is supplied with current, causing the flange 50 of the control valve member 35 to be attracted by the second coil 52. As a result, the control valve member 35, reinforced by the force of the compression spring 50 and counter to the compression spring 49, is brought into contact, with its second first sealing face 42, with the second valve seat 47, so that the pump work chamber 18 communicates with the pressure chamber 32 and is disconnected from the relief chamber 31. The high pressure of the pump work chamber 18 thus prevails in the pressure chamber 32 and acts on the piston 33, as a result of which the force of the closing spring 29 is in turn increased and as a result of that, the fuel injection valve 20 is closed. For a further fuel injection, the second coil 52 is no longer supplied with current, and instead the first coil 51 is again supplied with current, so that the control valve member 35 with its first sealing face 36 again rests on the first valve seat 45 and disconnects the pressure chamber 32 from the pump work chamber 18. To terminate the fuel injection, current is not supplied to either of the two coils 51, 52, and the control valve member 35 is thus in its middle position, and the pump work chamber 18 communicates with the relief chamber 31, so that high pressure can no longer build up in the pump work chamber 18, and the fuel injection valve is closed by the force of the closing spring 29 exerted on the injection valve member 22. An interruption in the fuel injection, brought about as explained above by the control valve device 30, can be provided in order to attain a preinjection of a slight fuel quantity, before the injection of a greater main injection quantity, and/or to attain a postinjection of a slight fuel quantity, after the injection of a greater main injection quantity.

In FIGS. 2-4, the fuel injection system is shown in a second exemplary embodiment; compared to the first exemplary embodiment, essentially only the control valve device 130 is modified. By means of the control valve device 130, the communication of the pump work chamber 18 with the relief chamber 31 and the communication of the pump work chamber 18 with the pressure chamber 32 are controlled. The control valve device 130 has two separate control valve members 160, 180, which are disposed offset coaxially from one another in the longitudinal direction and are guided displaceably in the longitudinal direction. The communication of the pump work chamber 18 with the relief chamber 31 is controlled by a first control valve member 160. The first control valve member 160 has a shaft 161, with which it is guided sealingly and displaceably in the longitudinal direction in a bore 162 of a control valve body. The shaft 161 is adjoined by a first sealing face 163, embodied for instance approximately conically, which is disposed at the transition of the control valve member 160 from the shaft 161 to a larger-diameter portion 164. A plunge cut 167 is embodied on the control valve member 160 between the shaft 161 and the sealing face 163. The portion 164 of the control valve member 160 is disposed in a bore portion 165 of the control valve body that has an increased diameter compared to the bore 162. At the transition from the bore portion 165 to the bore 162, an approximately conical first valve seat 166 is embodied, with which the first sealing face 163 of the first control valve member 160 cooperates. A connection 168 to the pump work chamber 18 discharges into the bore 162, and a connection to the relief chamber 31 discharges into the bore portion 165. Between the bottom of the bore portion 165 and the face end, toward it, of the control valve member 160, there is a prestressed compression spring 169, by which the control valve member 160, with its sealing face 163, is urged toward the valve seat 166.

The second control valve member 180 has a shaft 181, which protrudes into the bore 162 and which is adjoined, in the direction away from the first control valve member 160, by a portion 182 of greater diameter, which is disposed in a bore portion 183 of increased diameter compared to the bore 162. The portion 182 is adjoined on the second control valve member 180 by a further shaft 184 of smaller diameter, which is guided sealingly and displaceably in a bore 185 of the control valve body. At the transition from the portion 182 to the shaft 184, an approximately conical second sealing face 186 is embodied, and between that and the shaft 184, there is a plunge cut 187. An approximately conical second valve seat 189 is embodied at the transition from the bore portion 183 to the bore 185. Between an annular shoulder, formed at the transition from the bore 162 to the bore portion 183, and the face end, toward this annular shoulder, of the portion 182 of the control valve member 180, there is a prestressed compression spring 190, by which the control valve member 180, with its sealing face 186, is urged toward the valve seat 189. In the region of the plunge cut 187 of the control valve member 180, a connection 191 to the pump work chamber 18 discharges into the bore 185. A connection 192 to the pressure chamber 32 discharges into the bore portion 183.

On the end, remote from the sealing face 186, of the shaft 184 of the second control valve member 180, a shaft portion 194 of increased diameter is embodied. The shaft portion 194 is guided sealingly and displaceably in a cylinder 195. Between the end of the cylinder 195 and the face end, toward it, of the shaft portion 194, there is a prestressed compression spring 196, which counteracts the force of the compression spring 190. At the transition from the shaft 184 to the shaft portion 194, an annular face 197 remote from the compression spring 196 is formed on the control valve member 180. The end region of the second control valve member 180 having the annular face 197 is disposed in a control pressure chamber 198. The annular face 197 of the control valve member 180 is acted upon by the pressure prevailing in the control pressure chamber 198, which exerts a force counter to the compression spring 196 on the control valve member 180. The control pressure in the control pressure chamber 198 is determined by an actuator 199, which for instance is a piezoelectric actuator. The piezoelectric actuator 199 is connected to an electrical control unit 200, by which the magnitude of an electrical voltage applied to the piezoelectric actuator 199 is determined. Depending on the magnitude of this electrical voltage applied to it, the length of the piezoelectric actuator 199, and thus the control pressure in the control pressure chamber 198, changes. The piezoelectric actuator 199 can, via a hydraulic boost, determine the control pressure in the control pressure chamber 198, making it possible even at only slight changes in the length of the piezoelectric actuator 199 to achieve relatively major changes in the control pressure. If no electrical voltage is applied to the piezoelectric actuator 199 by the control unit 200, then the control pressure in the control pressure chamber 198 is so slight that the second control valve member 180 is lifted, with its sealing face 186, from the valve seat 189 by the force of the compression spring 196, counter to the force of the compression spring 190.

The function of the fuel injection system with the control valve device 130 in the second exemplary embodiment will now be explained. In the intake stroke of the pump piston 14, no voltage is applied to the piezoelectric actuator 199 by the control unit 200, and the control valve device 130 is in a first switching position, shown in FIG. 2. The second control valve member 180 at this time is lifted with its second sealing face 186 from the second valve seat 189 with a stroke h2 by the force of the compression spring 196, counter to the force of the compression spring 190. The second control valve member 180, with the face end of its shaft 181, contacts the face end of the shaft 161 of the first control valve member 160 and moves this member counter to the force of the compression spring 169, so that the first control valve member 160, with its first sealing face 163, is lifted from the first valve seat 166 with a stroke h1. The force exerted by the compression spring 196 on the second control valve member 180 and by way of the latter on the first control valve member 160 as well is thus greater than the total force exerted on the first control valve member 160 by the compression spring 169 and by the compression spring 190 on the second control valve member 180. In this intake stroke, the pump piston can aspirate fuel into the pump work chamber 18 from the relief chamber 31 through the bore portion 165, around the first control valve member 160 and through the connection 168.

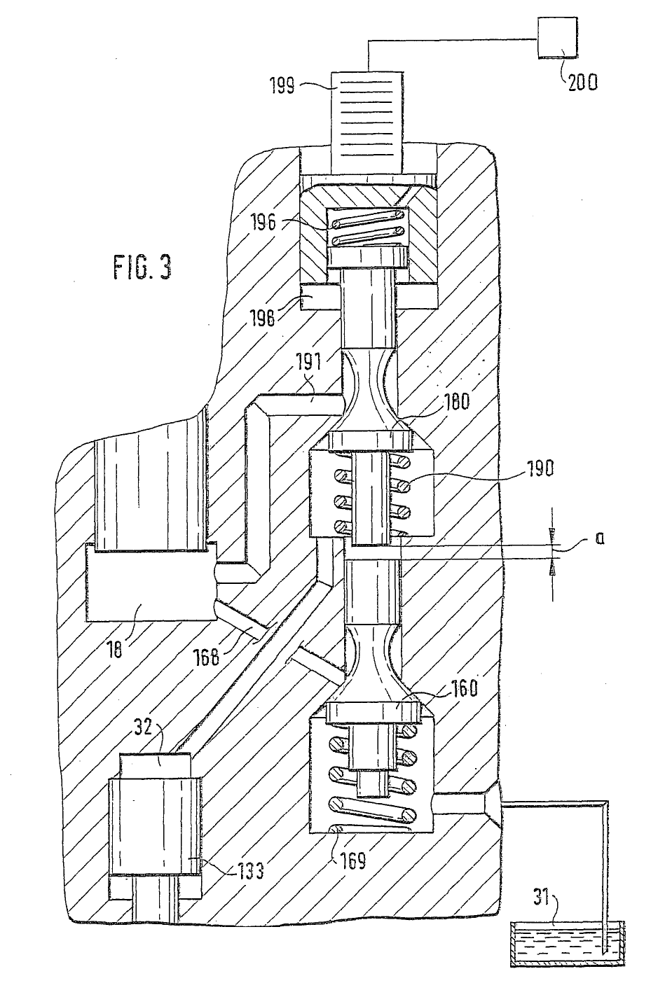

The instant of the onset of the fuel injection in the pumping stroke of the pump piston 14 is determined by the control unit 200 because this control unit applies a voltage to the piezoelectric actuator 199, and the control valve device 130 in a second switching position, shown in FIG. 3. The control pressure in the control pressure chamber 198 is increased as a result, so that in addition to the force of the compression spring 190, a compressive force counter to the force of the compression spring 196 acts on the second control valve member 180. The control valve member 180 thus moves in the longitudinal direction, until with its second sealing face 186 it comes into contact with the second valve seat 189, disconnecting the pump work chamber 18 from the pressure chamber 32. The first control valve member 160, as a result of the compression spring 169 acting on it, then also moves in the longitudinal direction, until with its first sealing face 163 it comes into contact with the first valve seat 166, so that the pump work chamber 18 is disconnected from the relief chamber 31 as well. In the pumping stroke of the pump piston 14, high pressure builds up in the pump work chamber 18, by means of which pressure the fuel injection valve 20 is opened, and fuel is injected into the combustion chamber of the engine.

When the first injection valve member 160 with its first sealing face 163 is resting on the first valve seat 166, and the second injection valve member 180, with its second sealing face 186, is resting on the second valve seat 189, the shaft 181 of the second control valve member 180 does not rest with its face end on the face end of the shaft 161 of the first control valve member 160; instead, there is a spacing a between them.

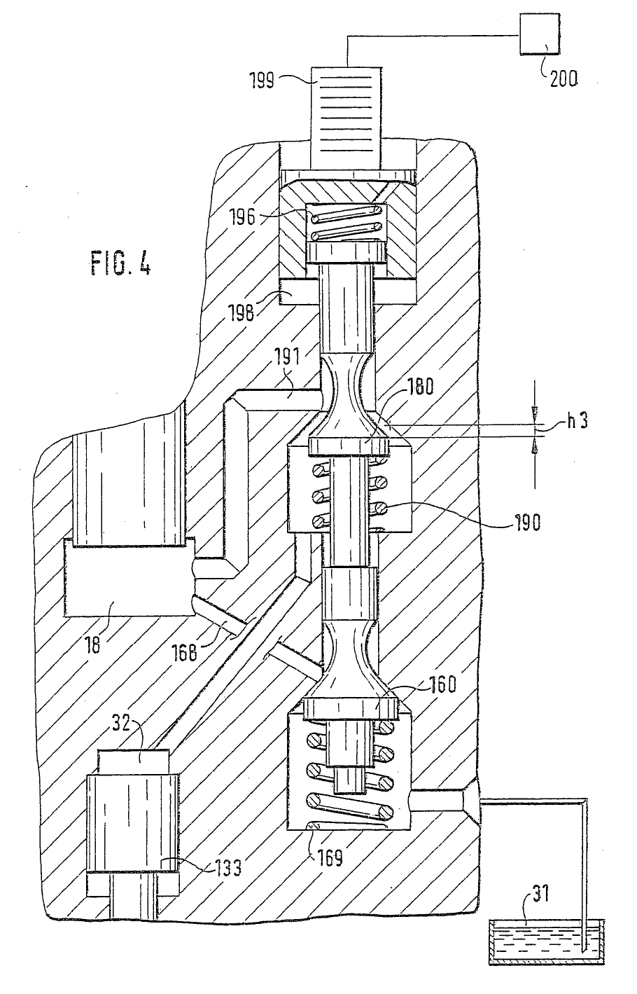

If the fuel injection is to be interrupted, for instance after a preinjection, then by means of the control unit 200, the electrical voltage applied to the piezoelectric actuator 199 is reduced, but not to zero, and the control valve device 130 is in a third switching position, shown in FIG. 4. This reduces the control pressure in the control pressure chamber 198, so that the force exerted by the compression spring 196 on the second control valve member 180 is greater than the force exerted by the compression spring 190 and by the control pressure. The second control valve member 180 then moves in the longitudinal direction and with its second sealing face 186, it lifts from the second valve seat 189 and executes a stroke h3, corresponding approximately to the spacing a from the first control valve member 160. However, the force exerted by the compression spring 196 does not suffice to move the first control valve member 160 as well in the opening direction counter to the force of the compression spring 169, and thus this control valve member with its first sealing face 163 remains in contact with the first valve seat 166 and does not enable any communication with the relief chamber 31. Thus the pump work chamber 18 communicates with the pressure chamber 32 via the opened second control valve member 180, so that high pressure prevails in this pressure chamber. A closing piston 133 acting on the injection valve member 22 is subjected to the high pressure prevailing the pressure chamber 32; the fuel injection valve 20 is closed by the high pressure prevailing the pressure chamber 32.

For a continuation of the fuel injection, for instance for the sake of a main injection, the control unit 20 increases the electrical voltage applied to the piezoelectric actuator 199 again, so that the second control valve member 180 moves in the longitudinal direction by the force of the compression spring 190 and the force caused by the control pressure and comes to rest, with its second sealing face 186, on the second valve seat 189, and the control valve device 30 is again in its second switching position, shown in FIG. 3. The pressure chamber 32 is then preferably made to communicate with the relief chamber 31 in order to relieve it and to enable the opening of the fuel injection valve 20. The communication of the pressure chamber 32 with the relief chamber 31 can preferably be controlled by the second control valve member 180.

For a further interruption in the fuel injection after the main injection, the fuel injection valve 20 can be closed again, by putting the control valve device 30 into its third switching position, shown in FIG. 4, in which the pressure chamber 32 communicates with the pump work chamber 18 by means of the second control valve member 180. Next, the fuel injection valve 20 can be opened again for another fuel injection, for instance a postinjection, by putting the control valve device 130 into its switching position shown in FIG. 3; the second control valve member 180 disconnects the pressure chamber 32 from the pump work chamber 18 again and connects it to the relief chamber 31.

To terminate the fuel injection, the control unit 200 applies no further electrical voltage to the piezoelectric actuator 199, so that by means of the compression spring 196, the second control valve member 180 with its second sealing face 186 is lifted from the second valve seat 189, and also by it the first control valve member 160 with its first sealing face 163 is lifted from the first valve seat 166. The stroke that the first control valve member 160 executes in the longitudinal direction, from its closed position in the second switching position of the control valve device 130 in FIG. 3 to its open position in the third switching position of the control valve device 130 in FIG. 4, is greater, by the spacing a than the stroke that the second control valve member 180 executes in the longitudinal direction from its closed position, in the second and third switching positions of the control valve device 130 in FIG. 3 and FIG. 4, into its open position, in the switching position of the control valve device 130 in FIG. 2.

The cylinder 16 with the pump piston 14 and the pump work chamber 18, the fuel injection valve 20, and the control valve device 30 in the first exemplary embodiment, and the control valve device 130 in the second exemplary embodiment, preferably form a common structural unit, in the form of a unit fuel injector.

1. A fuel injection system for an internal combustion engine, having a pump work chamber (18), which is defined by a pump piston (14) and can be filled with fuel via a connection controlled by a control valve device (30; 130) and can be made to communicate with a relief chamber (31), wherein during a given fuel injection, the pump work chamber (18) is disconnected from the relief chamber (31) by the control valve device (30; 130) and to terminate the fuel injection is made to communicate with the relief chamber (31) by the control valve device (30; 130), having a fuel injection valve (20) with an injection valve member (22) that controls at least one injection opening (23) and is acted upon in the opening direction (28), counter to a closing force, by the pressure prevailing in the pump work chamber (18), characterized in that by the control valve device (30; 130), for interrupting the fuel injection, a communication of the pump work chamber (18) with a pressure chamber (32) is also controlled, and the injection valve member (22) is urged in the closing direction at least indirectly by the pressure prevailing in the pressure chamber (32).

2. The fuel injection system of claim 1, characterized in that for the fuel injection, the pump work chamber (18) is disconnected by the control valve device (30; 130) from the relief chamber (31) and from the pressure chamber (32).

3. The fuel injection system of claim 1 or 2, characterized in that to terminate the fuel injection, the pump work chamber (18) is made by the control valve device (30; 130) to communicate with the relief chamber (31) and the pressure chamber (32).

4. The fuel injection system of one of claims 1-3, characterized in that the control valve device (30) has a control valve member (35), which is movable in a longitudinal direction by at least one actuator (51, 52); that the control valve member (35), with a first sealing face (36), cooperates in a first longitudinal direction with a first valve seat (45) to control the communication between the pump work chamber (18) and the relief chamber (31); and that the control valve member (35), with a second sealing face (42), cooperates in the opposite longitudinal direction with a second valve seat (47) to control the communication between the pump work chamber (18) and the pressure chamber (32).

5. The fuel injection system of claim 4, characterized in that for the motion of the control valve member (35) in both longitudinal directions, separate actuators (51, 52) are provided.

6. The fuel injection system of claim 4 or 5, characterized in that the at least one actuator (51, 52) is an electromagnet.

7. The fuel injection system of one of claims 1-3, characterized in that the control valve device (130) has two separate control valve members (160, 180), which are movable in a longitudinal direction and are offset from one another; that a first control valve member (160) with a first sealing face (163) cooperates in a longitudinal direction with a first valve seat (166) for controlling the communication between the pump work chamber (18) and the relief chamber (31); and that a second control valve member (180) with a second sealing face (186) cooperates in the same longitudinal direction with a second valve seat (189) for controlling the communication between the pump work chamber (18) and the pressure chamber (32); and that both control valve members (160; 180) are preferably movable by a single actuator (199).

8. The fuel injection system of claim 7, characterized in that by means of the actuator (199), the second control valve member (180) is movable by a first stroke (h3) in the longitudinal direction, so that with its second sealing face (186) it lifts from the second valve seat (189) and opens the communication between the pump work chamber (18) and the pressure chamber (32), while the first control valve member (160) with its first sealing face (163) remains in contact with the first valve seat (166), so that the pump work chamber (18) is disconnected from the relief chamber (31).

9. The fuel injection system of claim 8, characterized in that by the actuator (199), the second control valve member (180) is movable in the longitudinal direction by a second, longer stroke (h2), so that it comes to rest on the first control valve member (160), and the latter, with its first sealing face (163), lifts from the first valve seat (166) with a shorter stroke (h1) than the second stroke (h2) of the second control valve member (180).

10. The fuel injection system of one of claims 7-9, characterized in that the two control valve members (160, 180) are each urged with their sealing face (163, 186) toward the respective valve seat (166, 189) by a respective closing spring (169, 190).

11. The fuel injection system of one of claims 7-10, characterized in that the second control valve member (180) is urged in the opening direction by a spring (196) and is urged in the closing direction by the control pressure prevailing in a control pressure chamber (198); and that the control pressure is controlled by the actuator (199).

12. The fuel injection system of one of claims 7-11, characterized in that the actuator (199) is a piezoelectric actuator, which changes its length as a function of an electrical voltage applied to it.

13. The fuel injection system of one of the foregoing claims, characterized in that a longitudinally displaceably guided piston (33; 133) is acted upon by the pressure prevailing in the pressure chamber (32) and acts at least indirectly in the closing direction on the injection valve member (22).
